(19) United States
(12) Patent Application Publication
(10) Pub. No.: US 2026/0364511 A1
(43) Pub. Date: Nov. 19, 2026

(54) CARBON DIOXIDE RECOVERY DEVICE

(71) Applicant: HONDA MOTOR CO., LTD., Tokyo (JP)

(72) Inventors: Masanobu TAKAZAWA, Saitama (JP); Subaru MATSUMOTO, Tokyo (JP); Toshiyuki INABA, Saitama (JP); Shumon HOSHINO, Saitama (JP)

(21) Appl. No.: 19/136,490

(22) PCT Filed: Dec. 4, 2023
(86) PCT No.: PCT/JP2023/043308

§ 371 Date: Jun. 6, 2025

(30) Foreign Application Priority Data
Dec. 6, 2022 (JP) 2022-195163

(51) Int. Cl. B01D 53/04

(52) U.S. Cl. CPC B01D 53/0438; B01D 53/0454; B01D 2257/504; B01D 2259/40098

(57) ABSTRACT

This carbon dioxide recovery device comprises: a plurality of carbon dioxide recovery modules including an adsorbent that adsorbs and desorbs carbon dioxide, and which perform an adsorbing process and a desorbing process; a heat pump which moves heat energy between the plurality of carbon dioxide recovery modules; and a control unit. The control unit drives the carbon dioxide recovery modules by equivalently shifting the phases of the operation cycles. The number of carbon dioxide recovery modules is an integral multiple of a number N0 that satisfies formula 2, where the time required for the adsorbing process is x seconds, the time required for the desorbing process is y seconds, and the allowable time difference between the start time of a carbon dioxide recovery module that has started the adsorbing process and the start time of a carbon dioxide recovery module that has started the desorbing process is z seconds.

### TECHNICAL FIELD

The present invention relates to a carbon dioxide recovery device.

### BACKGROUND ART

Thus far, efforts focusing on the mitigation or impact abatement of climate change are currently underway, and research and development into carbon dioxide emission reduction directed towards this goal is being carried out. As one of the efforts, technology for capturing carbon dioxide in the atmosphere, and storing the captured carbon dioxide in the form of gas, liquid or the like underground, technology for converting the captured carbon dioxide as the carbon source into valuables such as fuel, chemicals, etc. have been proposed. Thereamong, the capture of carbon dioxide by Direct Air capture (DAC) has been proposed. For example, Patent Document 1 proposes a technique for bringing steam into contact with an adsorbent to release carbon dioxide, upon recovering carbon dioxide adsorbed to the adsorbent.

### CITATION LIST

### Patent Document

Patent Document 1: Japanese Unexamined Patent Application (Translation of PCT Application), Publication No. 2017-528318

### DISCLOSURE OF THE INVENTION

### Problems to be Solved by the Invention

Such a carbon dioxide recovery device performs an adsorption step of adsorbing carbon dioxide to a solid adsorption material, and a desorption step of desorbing the carbon dioxide from the adsorption material. This adsorption step and desorption step are alternately performed repeatedly. Due to the characteristics of the absorption material, the adsorption step is performed with the adsorption material at room temperature (25 °C), and the desorption step is performed with the adsorption material at high temperature (for example, 90 °C).

In the case of establishing a carbon dioxide recovery device including a plurality of modules, each equipped with an adsorption material, and operating by shifting the phase of the operating cycle of each module, it is necessary to supply thermal energy corresponding to the thermal mass of the adsorption material, heat of desorption of carbon dioxide, etc., i.e. thermal energy required in the desorption step by a heat pump or the like in accordance with the operating cycle of each module. However, there has been a problem in that a large amount of electric power is consumed in the supply of this thermal energy.

The present invention has an object of solving the above-mentioned problem, and providing a carbon dioxide recovery device that can operate a heat pump with higher COP, and thus can reduce the electric power consumed in the supply of thermal energy. Further, this consequently contributes to the mitigation or impact abatement of environmental change.

### Means for Solving the Problems

(1) A carbon dioxide recovery device includes: a plurality of carbon dioxide recovery modules, each including an adsorption material that adsorbs and desorbs carbon dioxide, and performing an adsorption step of adsorbing carbon dioxide to the adsorption material, and a desorption step of desorbing the carbon dioxide adsorbed to the adsorption material; a heat pump that transfers thermal energy between a plurality of the carbon dioxide recovery modules; and a controller that controls operation of the carbon dioxide recovery modules and the heat pump, in which the controller drives each of the carbon dioxide recovery modules in an operation cycle of alternately performing the adsorption step and the desorption step, and drives the plurality of the carbon dioxide recovery modules by evenly shifting a phase of the operation cycle of each, in which the heat pump causes thermal energy to transfer from the carbon dioxide recovery module which is in a latter half of the desorption step or a first half of the adsorption step to the carbon dioxide recovery module which is immediately before start of the desorption step or in a first half of the desorption step, and in which a number of the carbon dioxide recovery modules is an integer multiple of a number N0 satisfying an Equation 2 below, when setting a time required for the adsorption step as x seconds, setting a time required for the desorption step as y seconds, and setting a time difference allowed between a point in time when starting the adsorption step of the carbon dioxide recovery module having started the adsorption step, and a point in time when starting the desorption step of the carbon dioxide recovery module having started the desorption step as z seconds.

$$\begin{matrix}[ Expression 1 ] & \\ \vert \frac{x + y}{N 0} - y \vert ≦ z & ( Formula 2 )\end{matrix}$$

(2) It is preferable for the heat pump to supply thermal energy recovered from the carbon dioxide recovery module which is in the latter half of the desorption step or the first half of the adsorption step to the carbon dioxide recovery module which is immediately before start of the desorption step or in the first half of the desorption step.

### Effects of the Invention

(1) According to the present invention, it is possible to provide a carbon dioxide recovery device that can operate the heat pump at higher COP, and thus can reduce the electric power consumed in the supply of thermal energy.

(2) In addition, since the heat pump supplies the thermal energy recovered from the carbon dioxide recovery module which is in the latter half of the desorption step or the first half of the adsorption step to the carbon dioxide recovery module which is immediately before start of the desorption step or in the first half of the desorption step, it is possible to supply the thermal energy required in the desorption step with little electric power.

### BRIEF DESCRIPTION OF THE DRAWINGS

FIG. 1 is a view showing an outline configuration of a carbon dioxide recovery device 1 according to an embodiment;

FIG. 2 is a perspective view showing a module unit 10 according to the embodiment;

FIG. 3 is a perspective view of a module 11 according to the embodiment;

FIG. 4 provides graphs for explaining an operating state and output ratios of an adsorption device and desorption device in the case of there being one module 11 in the module unit 10;

FIG. 5 provides graphs for explaining an operating state of an adsorption device and desorption device and output ratio in the case of there being two modules 11 in the module unit 10;

FIG. 6 provides graphs for explaining an operating state of an adsorption device and desorption device and output ratio in the case of there being sixteen modules 11 in the module unit 10;

FIG. 7 provides graphs showing the relationship between the output ratio of the adsorption device and desorption device in an example of an operation cycle shown in FIGS. 4 to 6, fluctuation range which is the difference of the output ratio of the operation upper limit and operation lower limit of each device, and the number of modules;

FIG. 8 provides graphs for explaining the recovery and supply of thermal energy between two modules 11;

FIG. 9 provides graphs showing the relationship between the time error Z0 and module number;

FIG. 10 provides graphs showing the number of modules and the operation of each module;

FIG. 11 is a view showing a heat-transfer medium circuit of a heat pump 80 in the embodiment;

FIG. 12 is a view showing an example of the flow of heat transfer medium in the heat-transfer medium circuit of the heat pump 80;

FIG. 13 is a view showing an example of the flow of the heat transfer medium in the heat-transfer medium circuit of the heat pump 80;

FIG. 14 is a view showing an example of a heat-transfer medium circuit of the heat pump 80 in the case of establishing N×2 number of modules; and

FIG. 15 is a view showing an example of the flow of heat transfer medium in a heat exchanger 16.

### PREFERRED MODE FOR CARRYING OUT THE INVENTION

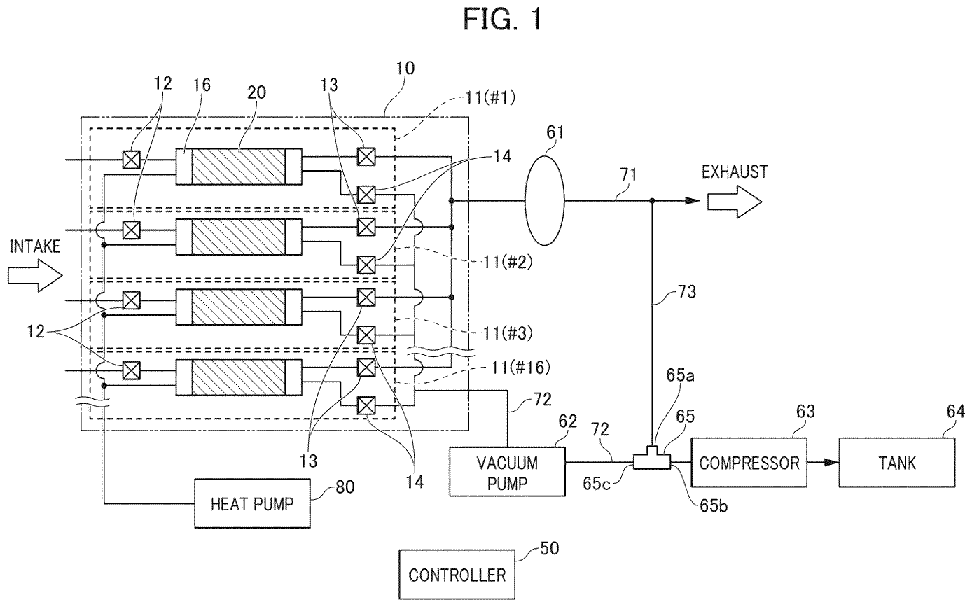

Hereinafter, embodiments of the present invention will be explained while referencing the drawings, etc. It should be noted that each of the drawings shown below including FIG. 1 are schematically illustrated drawings, and the size and shape of each component are exaggerated where appropriate in order to facilitate understanding.

### EMBODIMENTS

FIG. 1 is a view showing an outline configuration of a carbon dioxide recovery device 1 according to the present embodiment. The carbon dioxide recovery device 1, for example, is applied to Direct Air Capture (DAC) which recovers carbon dioxide in the atmosphere in order to decrease the carbon dioxide concentration in the atmosphere. Carbon dioxide recovered by the carbon dioxide recovery device 1 is reused as fuel or materials.

The carbon dioxide recovery device 1 includes a module unit 10, a fan 61, a vacuum pump 62, a compressor 63, a tank 64, a heat pump 80, a controller 50, an exhaust line 71, a carbon dioxide recovery line 72, etc. The carbon dioxide recovery device 1 recovers carbon dioxide in an aspirated gas such as the atmosphere by making adsorb to an adsorption material 20 in a module 11. Then, the carbon dioxide recovery device 1 desorbs the recovered carbon dioxide and stores in a tank 64, and exhausts a gas other than carbon dioxide to outside of the carbon dioxide recovery device 1. In the following description, the flow of gas from “intake” to “exhaust” shown in FIG. 1 (i.e. flow of gas from the left to right in the paper plane of FIG. 1) is defined as flow from upstream to downstream.

The controller 50 controls the operation of each component of the carbon dioxide recovery device 1. The controller 50, for example, controls operations such as the open/close operation of the valves 12, 13 and 14 provided to each module 11, and driving and stopping of devices used in the adsorption and desorption of carbon dioxide such as the fan 61, vacuum pump 62 and heat pump 80. This controller 50, for example, includes a CPU (Central Processing Unit), ROM (Read Only Memory), RAM (Random Access Memory), etc.

The module unit 10 is configured by a plurality of modules 11 being arranged in parallel. The present embodiment is described, as an example, by giving an example in which the module unit 10 includes sixteen of the modules 11. FIG. 1 is illustrated by attaching numbers in sequence as “(#1)” and “(#2)” after the reference number in order from the upper side in the paper plane to the modules 11 in the module unit 10.

The module 11 is a carbon dioxide recovery module including an adsorption material 20 that adsorbs carbon dioxide inside thereof. This module 11 includes a valve 12 located on the upstream side of the adsorption material 20, and valves 13 and 14 provided on the downstream side of the adsorption material 20. The valve 12 is an inlet taking in atmospheric air, etc. into the module 11, and the valve 13 is an outlet discharging the gas to outside of the module 11. The valve 13 is connected to an exhaust line 71 for discharging the gas having passed through the module 11 to outside of the carbon dioxide recovery device 1.

The valve 14 is an outlet that discharges gas to outside of the module 11, and is connected to a carbon dioxide recovery line 72 to which a tank 64, etc. for storing the recovered carbon dioxide are provided. The plurality of modules 11 of the module unit 10 are connected in parallel to the exhaust line 71 via the valves 13, and connected in parallel to the carbon dioxide recovery line 72 via the valves 14.

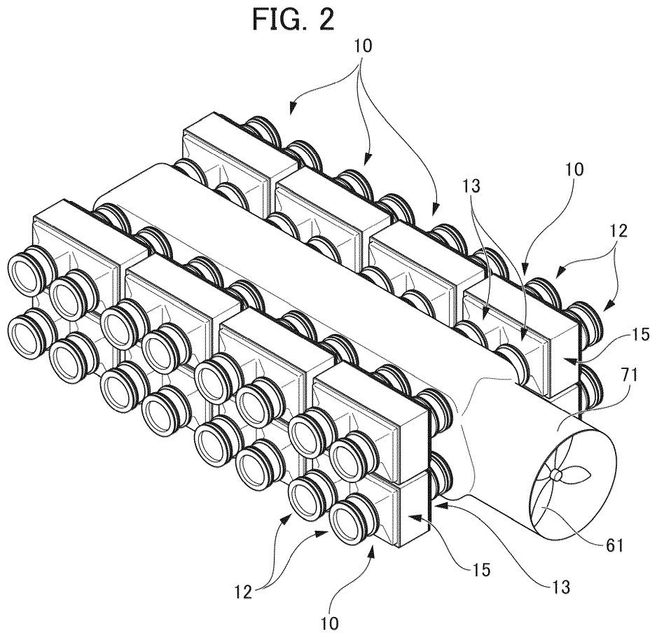

It should be noted that FIG. 1 shows an example in which one of each of the valve 12 and the valve 13 is provided to one module 11 in order to facilitate understanding. However, in the carbon dioxide recovery device 1 of the present embodiment, two of each are actually provided in one module 11, as shown in FIGS. 2, etc. described later. The details of the shape, etc. of this module 11 will be described later.

By being driven, the fan 61 causes a flow of gas to generate from the “intake” to “exhaust” of the module unit 10. The atmospheric air is thereby supplied into the module 11. In the present embodiment, one fan 61 is provided in the exhaust line 71 which is on the downstream side of the module unit 10, as shown in FIG. 1. It should be noted that, not to be limited thereto, an intake line (not shown) that is connected to the valve 12 of each module 11 on the upstream side of the module unit 10 and supplies the gas to the module 11 may be provided, and one fan 61 may be provided thereto, or a form may be established providing one fan to each of the intake line on the upstream side and the exhaust line 71 on the downstream side of the module unit 10.

The vacuum pump 62 is located on a downstream side of the module unit 10, and is provided to the carbon dioxide recovery line 72. The vacuum pump 62 aspirates the gas inside of the module 11 to establish the surroundings of the adsorption material 20 as a vacuum. In addition, the vacuum pump 62 aspirates the carbon dioxide desorbed from the adsorption material 20 and guides to a compressor 63 that is located further to the downstream side of the carbon dioxide recovery line 72.

The compressor 63 is located on the downstream side of the vacuum pump 62, and is provided in the carbon dioxide recovery line 72. The compressor 63 is a compression machine that compresses the carbon dioxide desorbed from the adsorption material 20 at a predetermined pressure. The tank 64 is located on the downstream side of the compressor 63, and is connected to the carbon dioxide recovery line 72. The tank 64 stores the carbon dioxide compressed by the compressor 63 in a predetermined state (gas or liquid state).

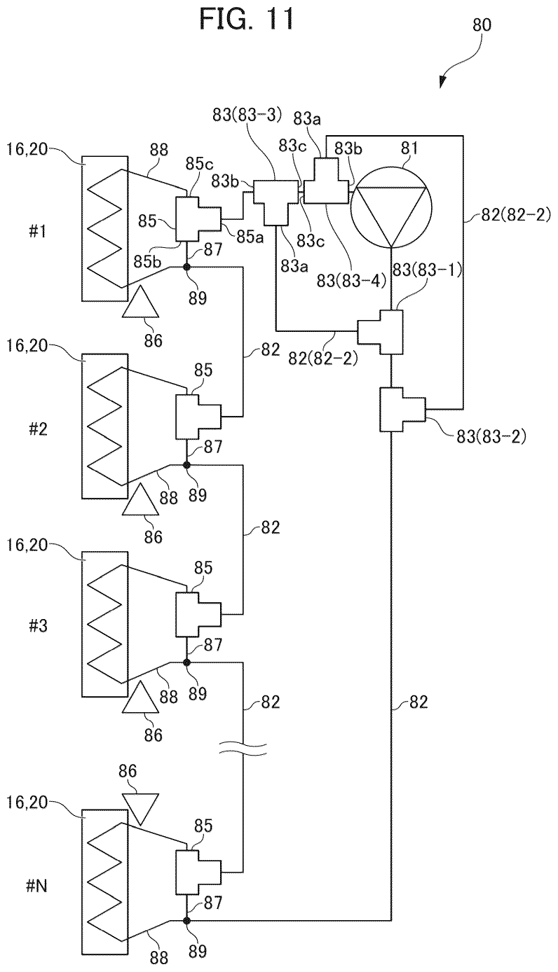

The heat pump 80 supplies thermal energy for heating inside of the module 11 to a predetermined temperature, upon each module 11 of the module unit 10 performing the desorption step. In addition, the heat pump 80 recovers the unneeded thermal energy upon each module 11 performing the adsorption step. This heat pump 80 is a so-called waste heat recovery-type heat pump. The heat pump 80 includes a pipe 82, etc. (refer to FIG. 11 described later) filled with a heat transfer medium (not shown). The pipe 82 is a flow channel through which the heat transfer medium flows. The heat pump 80 supplies thermal energy to each module 11, and recovers the unneeded thermal energy by way of the heat transfer medium passing through this pipe 82. The heat-transfer medium circuit of this heat pump 80 will be described in detail later.

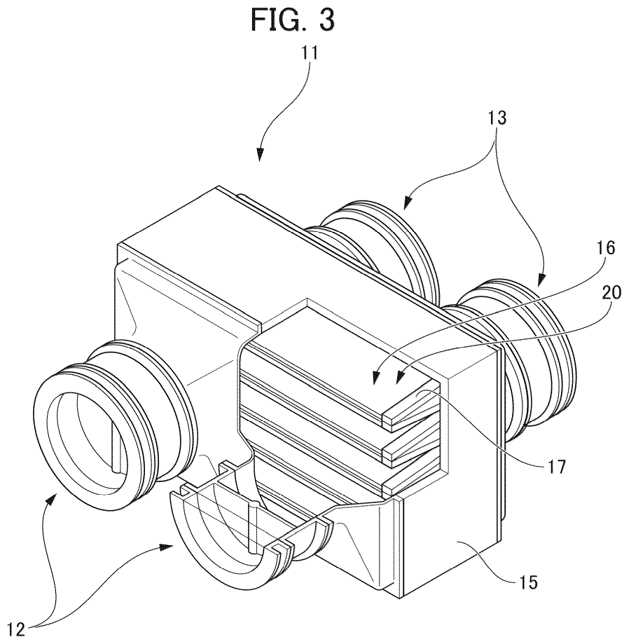

FIG. 2 is a perspective view of the module unit 10 according to the present embodiment. FIG. 2 is showing the module 11, the pipe which is the exhaust line 71, and the fan 61. FIG. 3 is a perspective view of the module 11 according to the present embodiment. FIG. 3 is also showing part of the inside of the module 11. The module unit 10 shown in FIG. 2 includes a total of sixteen modules 11, with eight on each of two opposing surfaces in a direction orthogonal to the extending direction (longitudinal direction) of the pipe which is the exhaust line 71. These modules 11 are provided to have the valves 13 connected to the exhaust line 71, and arranged in parallel to the exhaust line 71. The arrangement of the module 11 relative to the exhaust line 71 shown in FIG. 2 is an example, and it may be established as an arrangement other than this.

As shown in FIG. 3, the module 11 includes a box-shaped housing 15, a heat exchanger 16 arranged inside this, and the valves 12 and the valves 13 provided to two opposing surfaces of the housing 15. The module 11 further includes a valve 14 (not shown) in FIG. 3. This valve 14, for example, is provided via a branch (not shown), pipe, etc. more to the inner side of the housing 15 than a butterfly valve of the valve 12, or more to an inner side of the housing 15 than a butterfly valve (not shown) of the valve 13. The valve 14, branches of these, etc. are omitted from illustration from the viewpoint of facilitating understanding in FIGS. 2 and 3. The housing 15 is a box-shaped member, and includes a heat exchanger 16 inside thereof. The present embodiment is described, as an example, by giving an example in which the housing 15 is a rectangular parallelopiped shape.

The valves 12, 13 and 14 are valves which control the influx of gas into the housing 15 of the module 11, and discharge of gas to outside the housing 15. The valve 12 is an inlet of gas to the housing 15, and the valve 13 and the valve 14 are outlets of gas from the housing 15. By the valve 12 and the valve 13 being opened, gas containing carbon dioxide (for example, atmospheric air) is supplied to the adsorption material 20 inside the housing 15 of the module 11, and the gas having passed through the adsorption material 20 is discharged to the exhaust line 71. The valve 14 (refer to FIG. 1) is connected with the carbon dioxide recovery line 72, and by this being opened, the carbon dioxide released from the adsorption material 20 is directed to the vacuum pump 62, etc. on the downstream side.

The heat exchanger 16 regulates the temperature of the surroundings by heat exchange by flowing coolant or the heat transfer medium which is the heat source supplied from the heat pump 80. In the present embodiment, the heat exchanger 16 is arranged by a plurality of layers 17 being laminated in a bellows shape in the height direction of the housing 15 by a jig or the like (not shown). The layers 17 include a plurality of thin plate-shaped fins (not shown) and a tube (pipe) (not shown). The particulate-shaped adsorption material 20 is filled between the fins. The tube is a pipe through which the heat transfer medium carrying out heat exchange flows.

The layers 17, as shown in FIG. 3, are arranged so that the mountain parts of the bellows of the layer 17 laminated in a bellows shape are located adjacent to the valve 12 and adjacent to the valve 13. By arranging the layers 17 in this way, it is possible to drastically increase the contact area with the aspirated gas (atmospheric air), and the adsorption material can efficiently adsorb carbon dioxide.

The module 11 of the present embodiment includes two of the valves 12 and two of the valves 13 relative to one housing 15. It should be noted that, not to be limiting, the valves 12 and the valves 13 may be established in a form providing 3 or more of each. In addition, the number of the valves 14 provided to the module 11 may be set as appropriate according to the installation position on the housing 15, etc. In the case of the module 11 according to the present embodiment, the number of valves 14 provided relative to one module 11, for example, may be set as appropriate between 1 and 16.

By providing a plurality of the valves 12 and the valves 13 serving as the inlet (intake port) and outlet (exhaust port) of gas in the housing 15 of one module 11, it is possible to decrease the pressure loss of gas during the influx of gas to inside of the housing 15 of the module 11, and during discharge of gas to outside the housing 15. Conversely, in the case of providing one of each of the valve 12 and the valve 13 to the housing 15, the change in diameter of the flow channel of gas becomes large, and thus the pressure loss also becomes large. In contrast, by providing a plurality of inlets and outlets, the change in diameter of the flow channel becomes small, and thus it is possible to decrease such a pressure loss. In addition, from the viewpoint of arranging a plurality of modules 11 including a plurality of the valves 12 and 13 in this way, it is preferable that the housing 15 is a rectangular parallelopiped shape.

The adsorption material 20 is a member in particulate form, and has a property of adsorbing carbon dioxide in a low-temperature (−30 °C to 50 °C) state, and desorbing (releasing) carbon dioxide in a high temperature (50 °C to 110 °C) and low carbon dioxide concentration of the surroundings. As such an adsorption material 20, for example, a carbon dioxide adsorption material formed by a solid amine or the like can be exemplified. The present embodiment is described, as an example, by giving an example establishing the temperature at which the adsorption material 20 performs carbon dioxide adsorption as 25 °C, which is room temperature, and establishing the temperature at which the adsorption material 20 performs carbon dioxide desorption as 90 °C.

### (Recovery of Carbon Dioxide)

The carbon dioxide recovery device 1 alternately performs the adsorption step of causing carbon dioxide in aspirated gas such as atmospheric air to adsorb to the adsorption material 20 inside the module 11, and the desorption step of causing the carbon dioxide adsorbed to the adsorption material 20 to be desorbed, and compresses the desorbed carbon dioxide and stores in the tank 64, thereby removing and recovering carbon dioxide in atmospheric air.

The adsorption step is a step of causing carbon dioxide to adsorb to the adsorption material 20 in the module 11. In the adsorption step, the valve 12 and the valve 13 of the module 11 are opened, and the valve 14 is closed. The fan 61 drives, whereby the flow of gas from upstream to downstream is generated to aspirate the gas (e.g., atmospheric air) containing carbon dioxide through the valve 12. The aspirated gas passes through the adsorption material 20 in the module 11. At this time, the inside of the module 11 is room temperature (25 °C), and the carbon dioxide in the gas is adsorbed to the adsorption material 20. Gasses other than carbon dioxide, e.g., nitrogen, oxygen, etc., is discharged to outside of the carbon dioxide recovery device 1 through the valve 13 and the exhaust line 71.

The desorption step is a step of causing the carbon dioxide on the adsorption material 20 within the module 11 to desorb. In the desorption step, the valve 12 and the valve 13 of the module 11 are closed, and the valve 14 is opened. The vacuum pump 62 runs to aspirate and reduce the pressure inside of the housing 15 of the module 11. At the same time, the heat transfer medium serving as a heat source flows within the heat exchanger 16 in the module 11 to supply thermal energy, and heats the heat exchanger 16 by way of the heat pump 80. The adsorption material 20 is also heated to a predetermined temperature (90 °C) sufficient for the desorption step, and the carbon dioxide adsorbed to the adsorption material 20 is desorbed.

The desorbed carbon dioxide is aspirated by the vacuum pump 62 to flow from the valve 14 through the carbon dioxide recovery line 72, and is led to the compressor 63. At this time, a carbon dioxide sensor and/or a flow meter (not shown) may be arranged in the carbon dioxide recovery line 72, to grasp the amount and/or concentration of desorbed carbon dioxide.

Then, the desorbed carbon dioxide is compressed by the compressor 63 and filled to the tank 64, or buried underground, in a predetermined state (liquid or gas). The carbon dioxide in a gas such as atmospheric air is thereby recovered by the carbon dioxide recovery device 1.

It should be noted that, as shown in FIG. 1, it may be established in a form in which a switching valve 65 is provided between the vacuum pump 62 and the compressor 63 in the carbon dioxide recovery line 72. The switching valve 65 is configured so as to be selectively switched between a state in which the port 65c and port 65b are in communication, and a state in which the port 65a and the port 65c are in communication. This switching is performed by the controller 50. The port 65c is connected to a side of the carbon dioxide recovery line 72 adjacent to the vacuum pump 62, and the port 65b is connected to a side of the carbon dioxide recovery line 72 adjacent to the compressor 63. The port 65a is connected to a second exhaust line 73 which is connected to the exhaust line 71.

For example, it may be established in a form which, during the driving initial stage of this carbon dioxide recovery device 1, until the amount or concentration of carbon dioxide flowing through the carbon dioxide recovery line 72 reaches a predetermined value, the gas arriving by flowing through the carbon dioxide recovery line 72 is flowed to the second exhaust line 73 by this switching valve 65, and discharged from the exhaust line 71 to outside of the carbon dioxide recovery device 1. In the case of the concentration of carbon dioxide being low and other gasses, etc. mixing thereinto, it is possible to exhaust without guiding to the compressor 63.

### (Number of Modules 11 in Module Unit 10)

As mentioned above, the module 11 alternately performs the adsorption step and desorption step according to the instructions of the controller 50, while the carbon dioxide recovery device 1 is running. With the carbon dioxide recovery device 1 of the present embodiment, sixteen of the modules 11 provided to the module unit 10 are driven with the phases of the operating cycle of each module 11 being equally shifted. For this reason, the carbon dioxide recovery device 1 performs the desorption step with at least one of the modules 11 and performs the adsorption step with the other modules 11 at arbitrary points in time in the operating state.

### (Setting of Number of Modules 11)

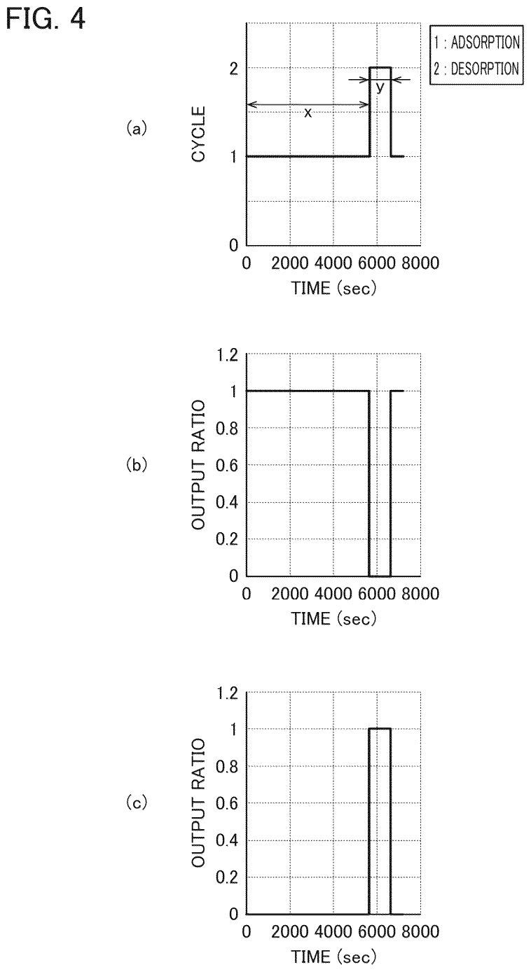

FIG. 4 is a view for explaining the operating state and output ratio of the adsorption device and desorption device in the case of there being one module 11 in the module unit 10. Herein, the adsorption device is a device for adsorption related to the adsorption step of the module 11, and is the fan 61 in the present embodiment. The desorption device is a device for desorption related to the desorption step of the module 11, and includes the vacuum pump 62 in the present embodiment, and in more detail, further includes the compressor 63 and the heat pump 80.

The graph shown in FIG. 4A shows the operating cycle of the adsorption device and the desorption device in the case of there being one module 11 in the module unit 10. The graph shown in FIG. 4B shows the relationship between the operating state and output ratio of the adsorption device in the operation cycle shown in FIG. 4A. The graph shown in FIG. 4C shows the relationship between the operating state and the output ratio of the desorption device in the operation cycle shown in FIG. 4A. In FIG. 4A, the vertical axis is the cycle, with 1 being the adsorption step and 2 being the desorption step, and the horizontal axis is time. In FIGS. 4B and C, the vertical axis is the output ratio, and the horizontal axis is time. In the output ratio of the vertical axis, the total output during driving of each device in each step of the one module 11 is 1.

The module 11 performs the adsorption step for x seconds, and performs the desorption step for y seconds. FIG. 4 and FIGS. 5 and 6 shown below show an example of x=5669 seconds and y=967 seconds as an example. In the case of the module unit 10 including one module 11, the fan 61 is running while the module 11 performs the adsorption step; however, the vacuum pump 62, the compressor 63 and the heat pump 80 are not running. Therefore, as shown in FIGS. 4B and 4C, the output ratio of the adsorption device during the adsorption step is 1, and the output ratio of the desorption ratio is 0.

In addition, in the module unit 10 including one module 11, the vacuum pump 62, compressor 63 and heat pump 80 are driven while the module 11 performs the desorption step; however, the fan 61 is not driven. Therefore, as shown in FIGS. 4B and 4C, the output ratio of the adsorption device during the desorption step is 0, and the output ratio of the desorption device is 1.

In other words, in the case of there being one module 11 in the module unit 10, the adsorption device (fan 61) and desorption device (vacuum pump 62, compressor 63 and heat pump 80) repeat driving and stopping every time the step changes, and thus operation is intermittent. For this reason, there is concern over a decline in the drive efficiency due to driving/stopping of the adsorption device and desorption device, a decline in durability of each device, etc. occurring.

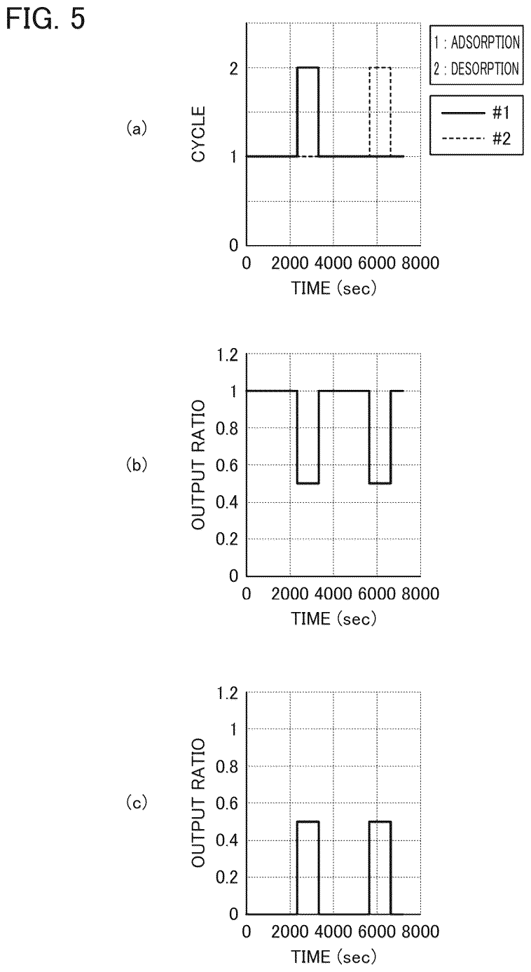

FIG. 5 is a view for explaining the operating state and output ratio of the adsorption device and the desorption device in the case of there being two modules 11 in the module unit 10. The graph shown in FIG. 5A shows the operation cycle of the adsorption device and desorption device in the case of there being two modules 11 in the module unit 10. The graph shown in FIG. 5B shows the relationship between the operating state and output ratio of the adsorption device in the operation cycle shown in FIG. 5A. The graph shown in FIG. 5C shows the relationship between the operating state and output ratio of the desorption device in the operation cycle shown in FIG. 5A. In FIG. 5A, the vertical axis is the cycle, 1 being the adsorption step, and 2 being the desorption step, and the horizontal axis is time. In FIGS. 5B and 5C, the vertical axis is the output ratio, and the horizontal axis is time. In the output ratio of the vertical axis, in the case of the two modules 11 both performing the adsorption step, the total output of each device when performing the desorption step is 1.

As shown in FIG. 5A, the two modules 11 are driven with the phases of the operation cycle being shifted by ½. As shown in FIGS. 5B and 5C, the output ratio of the adsorption device is 1, and the output ratio of the desorption device is 0, while the two modules 11 are both performing the adsorption step. While one of the modules 11 (for example, module 11 of No. 1 (#1)) performs the desorption step, and the other module (for example, module 11 of No. 2 (#2)) performs the adsorption step, the output ratio of the adsorption device is 0.5, and the output ratio of the desorption device is 0.5.

Therefore, the fluctuation range of the output of each device accompanying a switch in the operating state of each module is smaller for the case of there being two modules 11 in the module unit 10 than the case of there being one. In addition, the adsorption device is continuously driven, although there is a change in output ratio. On the other hand, the desorption device is intermittently driven.

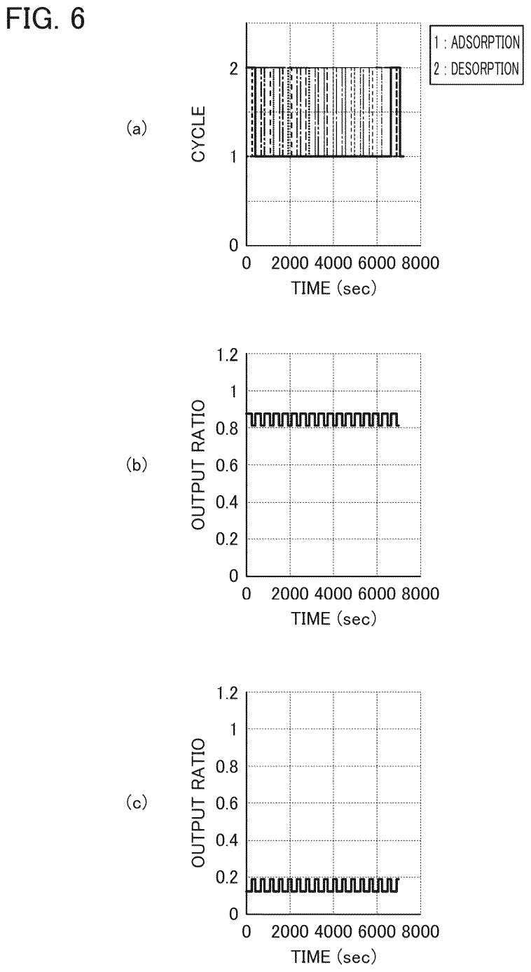

FIG. 6 provides graphs for explaining the operating state and output ratio of the adsorption device and the desorption device in the case of there being sixteen modules 11 in the module unit 10. The graph shown in FIG. 6A shows the operation cycle of the adsorption device and the desorption device in the case of there being sixteen modules 11 in the module unit 10. The graph shown in FIG. 6B shows the relationship between the operating state and the output ratio of the adsorption device in the operation cycle shown in FIG. 6A. The graph shown in FIG. 6C shows the relationship between the operating state and the output ratio of the desorption device in the operation cycle shown in FIG. 6A. In FIG. 6A, the vertical axis is the cycle, 1 being the adsorption step, and 2 being the desorption step, and the horizontal axis is the time. In FIGS. 6B and 6C, the vertical axis is the output ratio, and the horizontal axis is the time. In the output ratio of the vertical axis, the total output of the adsorption device in the case of the sixteen modules 11 all performing the adsorption step simultaneously, and the total output of the desorption device in the case of performing the desorption step are 1.

In the example shown in FIG. 6, as shown in FIG. 6A, a state in which two of the modules 11 among the sixteen modules 11 perform the desorption step, and a state in which three of the modules 11 temporarily perform the desorption step upon switching of the process of the modules 11, are alternately repeated. As shown in FIGS. 6B and 6C, while two of the modules 11 are performing the desorption step, the output ratio of the adsorption device becomes 0.875, and the output ratio of the desorption device becomes 0.125. In addition, while three of the modules 11 are performing the desorption step, the output ratio of the adsorption device is 0.8125, and the output ratio of the desorption step is 0.1875.

At this time, the adsorption device and the desorption device are both continuously driven, even when there is fluctuation in output ratio. Therefore, the driving of the adsorption device and the desorption device is more stable. In addition, at this time, the maximum outputs of the adsorption device and the desorption device are small compared to the maximum output in the case of driving all sixteen of the modules 11 in the same phase, and the performance demanded in each device becomes lower. It is thereby possible to curb the cost of each device, and thus possible to suppress the manufacturing cost of the carbon dioxide recovery device 1. Furthermore, at this time, the fluctuation ranges of the outputs of the adsorption device and the desorption device accompanying switching of the operating state of each module 11 are smaller, and each device performs more stable driving.

By establishing at least a predetermined number of modules 11 provided to the module unit 10 in this way, and evenly shifting the phase of the operation cycle of each module 11, it is possible to continuously drive the adsorption device and the desorption device. In the carbon dioxide recovery device 1, upon setting the time required in the adsorption step as x seconds, setting the time required in the desorption step as y seconds, and driving by evenly shifting the phases of the plurality of modules 11 in one module unit 10, the number N1 of modules among which at least one module 11 is performing the desorption step at any moment in time of the operation cycle is obtained by the following (Equation 1).

$$\begin{matrix}[ Expression 2 ] & \\ N 1 > max ( \frac{x + y}{x} , \frac{x + y}{y} ) & ( Formula 1 )\end{matrix}$$

By setting the number of modules 11 in the module unit 10 as at least a number N1 satisfying this (Equation 1), it is possible to continuously drive the adsorption device (fan 61) and the desorption device (vacuum pump 62, compressor 63, heat pump 80), and thus possible to improve the drive efficiency and durability of each device due to intermittent driving. In the present embodiment, as described above, when the time x required in the adsorption step equals 5669 seconds, and the time y required in the desorption step equals 967 seconds, and inputting to the above (Equation 1), then N1>6.8. Since the number of the modules 11 is a positive integer, 7 or more of the module 11 of the module unit 10 are preferably established. In the carbon dioxide recovery device 1 of the present embodiment, the module unit 10 includes sixteen of the modules 11, and satisfies the above (Equation 1).

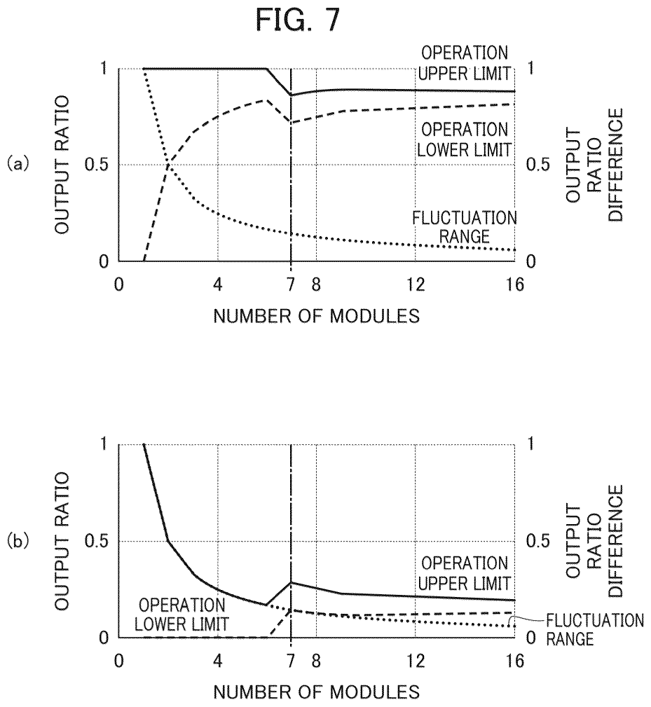

FIG. 7 provides graphs showing the relationship between the output ratios of the adsorption device and desorption device, fluctuation range which is the difference in output ratio between the operation upper limit and operation lower limit of each device, and the number of modules, in the example of the operation cycles shown in FIGS. 4 to 6. FIG. 7A shows the relationship between the output ratio of the adsorption device and the module number (number of modules 11 equipped to the module unit 10), and the relationship between the fluctuation range which is the difference in output ratio between the operation upper limit and operation lower limit of the adsorption device and the module number, and FIG. 7B shows the relationship between the output ratio of the desorption device and module number, and the relationship between the fluctuation range which is the difference in output ratio between the operation upper limit and operation lower limit of the desorption device and the module number. In the graph shown in FIGS. 7A and B, the vertical axis on the left side is the output ratio, the horizontal axis is the module number, and the vertical axis on the right side is the difference in output ratio. The operation upper limit corresponds to the total output of each device for each module number, and the operation lower limit corresponds to the lowest output of each device for each module number.

As shown in FIG. 7, with one module 11, the adsorption device and the desorption device shows a trend whereby the fluctuation range which is the difference in output ratio between the operation upper limit and the operation lower limit thereof is large, but the fluctuation range becomes smaller as the number of modules 11 increases. In the graphs shown in FIG. 7, when the number of modules 11 is seven, the output ratios of the operation upper limit and the operation lower limit of the adsorption device decrease. This is because, in the case of N1>6.8 in the aforementioned (Equation 1), and establishing seven of the modules 11, it becomes a state in which at least one of the modules 11 is performing the desorption step at any point in time of the operation cycle. In addition, when the number of the modules 11 is seven, the output ratios of the operation upper limit and the operation lower limit of the desorption device increase. This is because, in the case of establishing seven of the modules 11, since N1>6.8, strictly speaking, some time occurs when two of the modules 11 perform the desorption step of the operation cycle.

In view of the above, from the viewpoints of stable driving of the adsorption device and the desorption device, an improvement in drive efficiency and durability, cost reduction of each device, etc., it is preferable to establish N1 or more of the modules 11 provided in the module unit 10. In addition, since it is possible to continuously operate the fan, which is an adsorption device, and each module 11 is connected in parallel to the exhaust line 71, it is possible to use a fan of the appropriate flowrate, and improve the drive efficiency. In addition, it is possible to continuously drive the vacuum pump, etc., which are desorption devices, and thus improve the drive efficiency.

In addition, by setting the number of modules to the number N1 as described above, at least one of the modules 11 in the module unit 10 performs the desorption step. It is thereby possible to decrease the maximum output of each device. For example, if setting the module number to the number N (N≥N1, N is an integer), setting the number of the modules 11 performing the desorption step to the number m (m≥1, m is an integer), and setting the maximum output as 1 in the case of all N number of modules performing the adsorption step, the fan, which is a device for adsorption, can reduce output by m×1/N in the output ratio.

In view of the above, as in the present embodiment, in the case of the module unit 10 including sixteen of the modules 11, and driving by shifting the phases of the operation cycle evenly, it is preferable to control so that any two of the modules 11 are performing the desorption process at any point in time. At this time, it is preferable to control so as to drive by evenly shifting the phases of the operation cycle of the eight modules 11 and control so that any one of the modules 11 performs the desorption step at any point in time among the eight modules 11, and control as the module unit 10 overall so that any two of the modules 11 perform the desorption step at any point in time among the sixteen modules 11. It should be noted that there may be a state in which two modules 11 perform the desorption step among the eighth modules 11, and thus there may be a state in which three modules 11 among the sixteen modules 11 of the module unit 10 perform the desorption step, as in the example shown in FIG. 6 described above, for example.

### (Waste Heat Recovery by Heat Pump)

Next, the transfer of the thermal energy between the plurality of modules 11 by the heat pump 80 in the carbon dioxide recovery device by direct air capture (DAC) will be described. Generally, the thermal energy required upon the modules 11 performing the desorption step is large. For this reason, there is a demand to perform the supply of thermal energy to the modules 11 with less electric power.

Therefore, the carbon dioxide recovery device 1 includes a plurality of the modules 11, and sets the number of modules 11 so as to drive by evenly shifting the phases of the operation cycle of each module 11, combine, by a heat-transfer medium circuit of the heat pump 80, a module which is immediately before the start of the desorption step or in first half of the desorption step which requires thermal energy, and a module which is in the latter half of the desorption step or first half of the adsorption step which do not require thermal energy, whereby the recovery and supply of thermal energy is efficiently carried out.

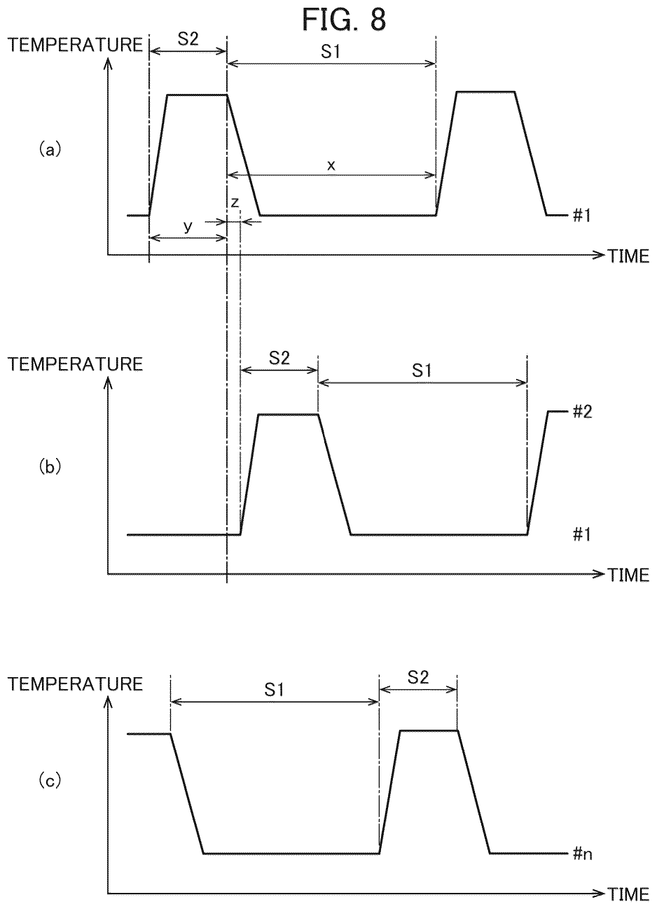

FIG. 8 provides graphs for explaining the recovery and supply of thermal energy between two of the modules 11. In the graphs shown in FIGS. 8A to 8C, the vertical axis is temperature, and the horizontal axis is time. FIG. 8A shows the relationship between the operation and temperature of the No. 1 (#1) module 11, FIG. 8B shows the relationship between the operation and temperature of the No. 2 (#2) module 11, and FIG. 8C shows the relationship between the operation and temperature of the No. n (#n) module 11. In addition, FIG. 8 indicates the adsorption step as S1 and the desorption step as S2. In FIG. 8, the first half of the adsorption step of the No. 1 (#1) module 11 and the first half of the desorption step of the No. 2 (#2) module 11 are corresponding and make a pair. However, the No. n (#n) module does not make a pair with either of the No. 1 (#1) and No. 2 (#2) modules 11.

In the carbon dioxide recovery device 1, when setting the time required by the module 11 for the adsorption step as x seconds, setting the time required in the desorption step as y seconds, and setting the time difference allowed between the adsorption step start time of the module 11 starting the adsorption step (No. 1 module in FIG. 8) among modules making a pair, and the desorption step start time of the module 11 (No. 2 module in FIG. 8) starting the desorption step as z seconds, the number N2 of modules, among which at least one pair of modules 11 making such a pair is present, is a positive integer multiple of a number N0 obtained by the following (Equation 2). In addition, this number N2 is 2 or more, and is preferably 3 or more.

$$\begin{matrix}[ Expression 3 ] & \\ \vert \frac{x + y}{N 0} - y \vert ≦ z & ( Formula 2 )\end{matrix}$$

By satisfying the above-mentioned (Equation 2), it is possible, by way of the heat pump 80, to recovery the thermal energy of the module 11 (No. 1 module) finishing the desorption step and starting the adsorption step, and supply the thermal energy to the module (No. 2 module) starting the desorption step, and thus possible to reduce the electrical power required in the supply of thermal energy.

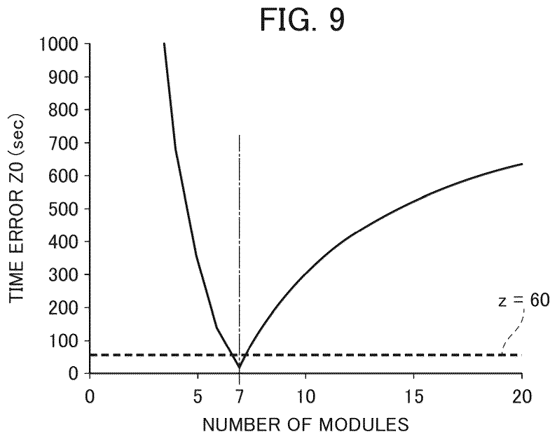

FIG. 9 is a graph showing the relationship between the time error Z0 and module number. In FIG. 9, the vertical axis is the time error Z0 (seconds), and the horizontal axis is the number N0 of modules 11 in (Equation 2). The graph indicated by a solid line in FIG. 9 is (Equation 2) left side Z0=|(x+y)/N0−y|, in the case of x=5669 seconds, and y=967 seconds. In the case of x=5669 seconds, and y=967 seconds, when assuming an allowed time difference z=60 seconds, the number N0 of modules 11 satisfying (Equation 2) is N0=7, as also shown in FIG. 9, and the number of modules in the module unit 10 is optimally a multiple of 7. In addition, in the case of x=5669 seconds, and y=967 seconds, the time error Z0 at N0=7 becomes a minimum; therefore, although depending on the allowed time difference z, the number N0 of modules is preferably 7 to 9, the number N2 of modules is preferably set to integer multiples thereof such as 7 to 9, 14 to 18, and 21 to 27. The present embodiment sets N0=8, and N2=N0×2, and provides sixteen of the modules 11. Therefore, in this case, the allowed time difference z is z≥137.5 seconds. It is preferable if the allowed time difference z is small because, as smaller, the overall time of the operation cycle of the carbon dioxide recovery device 1 can be made shorter. The allowed time difference z may be set as a predetermined value as appropriate according to the number of modules 11, usage environment thereof, etc., so that the carbon dioxide recovery device 1 is efficiently driven.

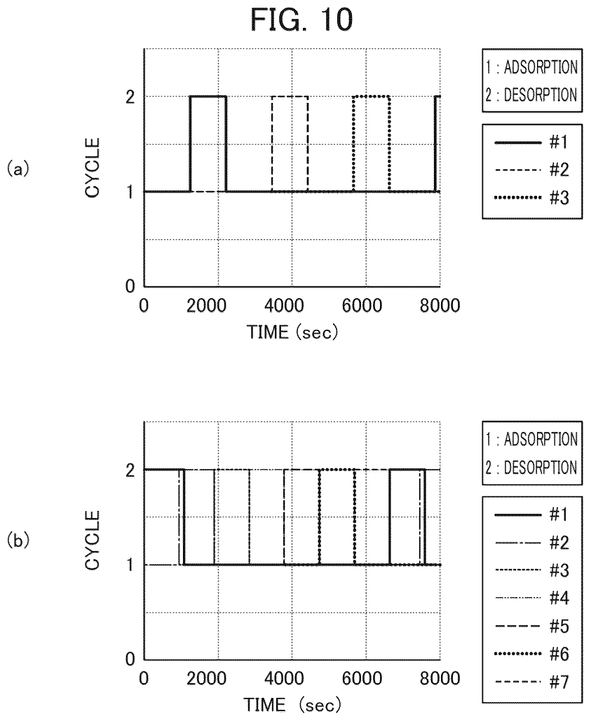

FIG. 10 provides graphs showing the number of modules and the operation of each module. In FIGS. 10A and 10B, the vertical axis is the cycle, and the horizontal axis is time. FIG. 10A shows an example in which the number of modules 11 in the module unit 10 is three, and FIG. 10B shows an example in which the number of modules 11 in the module unit 10 is seven. In addition, FIG. 10 is illustrated with the time x required in the adsorption step equal to 5669 seconds, and the time y required in the desorption step equal to 967 seconds. As shown in FIG. 10A, in the case of there being three of the modules 11, and driving by evenly shifting the phases of the operation cycle of each module, a module which is in the first half of the adsorption step and a module which is in the first half of the desorption step are not corresponding to make a pair. Therefore, it is not possible to send the recovered thermal energy to the module 11 which is in the first half of the desorption step in which thermal energy is required.

In contrast, as shown in FIG. 10B, in the case of there being seven of the modules 11, and driving by evenly shifting the phase of the operation cycle of each module, for example, the first half of the adsorption step of the No. 1 (#1) module 11 and the first half of the desorption step of the No. 2 (#2) module 11 are corresponding, and the first half of the adsorption step of the No. 2 (#2) module 11 and the first half of the desorption step of the No. 3 (#3) module are corresponding.

By establishing such a configuration, it is possible to recover the unwanted thermal energy from the module 11 starting the adsorption step, and efficiently supply to the module 11 starting the desorption step requiring thermal energy. It is thereby possible to drive the heat pump 80 with higher COP, and possible to reduce the electrical power consumed in the supply of thermal energy. It should be noted that COP is the ratio of heat output to the inputted heat quantity, and corresponds to a value arrived at by dividing the total heat amount received by the module having started the desorption step by the power of the compressor of the heat pump 80. COP indicates the efficiency of the heat pump 80, and with a larger value of COP, it expresses that a larger output could be obtained with smaller input.

The heat-transfer medium circuit of the heat pump 80 for realizing the aforementioned such efficient recovery and supply of thermal energy takes the form shown in FIG. 11 below. FIG. 11 is a view showing the heat-transfer medium circuit of the heat pump 80 in the present embodiment. In FIG. 11, the shape, etc. of the module is simplified to facilitate understanding and shows only a heat exchanger 16 (adsorption material 20). The heat pump 80 includes a compressor 81, a plurality of pipes 82, switching valves 83 (83-1 to 83-4), etc. The pipes 82 are connected as appropriate with the switching valve 83. In order to facilitate understanding, FIG. 11 is illustrated by indicating configurations shared between respective modules by attaching the same reference symbols thereto, and attaching numbers such as No. 1 (#1) and No. 2 (#2) thereto as appropriate.

This heat-transfer medium circuit is circuit provided with a heat pump supplying thermal energy to the module 11, in the carbon dioxide recovery device 1 including a plurality of modules 11 for carbon dioxide recovery including the adsorption material 20 that adsorbs and desorbs carbon dioxide, and performing the adsorption step causing carbon dioxide to adsorb to the adsorption material 20, and the desorption step of desorbing the adsorbed carbon dioxide. This heat-transfer medium circuit includes: a plurality of heat exchangers 16; the compressor 81 which is a compressing machine that compresses the heat transfer medium flowing in the heat exchanger 16; a main pathway that connects the compressor 81 and the plurality of heat exchangers 16 in series, and circulates the heat transfer medium; and a reversing mechanism that switches the heat transfer medium flowing in this main pathway in the first direction to a second direction that is the opposite direction from the first direction. These heat exchangers 16 are respectively arranged within each of the modules 11, and between two heat exchangers 16, the heat-transfer medium circuit 16 can cause at least part of the thermal energy adsorbed by the heat transfer medium in one heat exchanger 16 to transfer to the other heat exchanger 16.

In addition, in the carbon dioxide recovery device 1 including a plurality of the aforementioned such carbon dioxide recovery modules 11, this heat-transfer medium circuit is equipped with a heat pump supplying thermal energy to the modules 11, and includes at least three of the heat exchangers 16, the compressor 81 which is a compressing machine that compresses the heat transfer medium flowing in the heat exchangers 16, and a main pathway that connects the compressor 81 and the plurality of heat exchangers 16 in series, and causes the heat transfer medium to circulate therein. The heat exchangers 16 include, in every heat exchanger 16, a bypass part which is arranged within each of the modules 11, and selectively circumvents the influx of heat transfer medium to the heat exchanger 16 not conducting the transfer of thermal energy, and between two of the heat exchangers 16, causes at least part of the thermal energy adsorbed by the heat transfer medium in one heat exchanger 16 to transfer to the other heat exchanger 16.

Each of the modules is provided with a tube 88 in which the heat transfer medium flows within the heat exchanger 16, an expansion valve 86 provided in the tube 88, a switching valve 85 that switches the influx of heat transfer medium to the heat exchanger 16, a bypass 87 that connects the port 85b of the switching valve 85 with the pipe 82, a branch 89 that connects the bypass 87 and pipes 82, 88, etc. It should be noted that, only in the No. N (#N) module, the expansion valve 86 is located in the tube 88 on the port 85c side of the switching valve 85, and is provided to the tube 88 adjacent to the branch 89 in the other modules.

The pipe 82 connected to the compressor 81 is connected with a plurality of switching valves 83, and by switching the communication of the switching valve 83, serves as a means that can change the advancing direction and/or flowpath of the heat transfer medium in this heat-transfer medium circuit. The pipe 82 forms the main pathway in which the heat transfer medium flows. In addition, the switching valve 83 and a part of the pipe 82-2 connected to the pipe 82 serving as the main pathway via the switching valve 83 is a reversing mechanism that can reverse the flowpath. The opening/closing of these switching valves 83 and 85, opening/closing of the expansion valve 86, control of branching, etc. are performed by the controller 50.

Hereinafter, the transfer of thermal energy by the heat-transfer medium circuit of the heat pump 80 of the present embodiment will be described. In order to facilitate understanding, as an example, the present embodiment is described giving an example in which, the desorption step is performed in order from a module of smaller number such that, when the No. 1 (#1) module finishes the desorption step and starts the adsorption step, the No. 2 (#2) module starts the desorption step, and when the No. 2 (#2) module finishes the desorption step and starts the adsorption step, the No. 3 (#3) module starts the desorption step, and the thermal energy mainly transfers between two adjacent modules such as from No. n to No. (n+1). It should be noted that two modules among which thermal energy transfers are not limited to adjacent positions in the heat-transfer medium circuit.

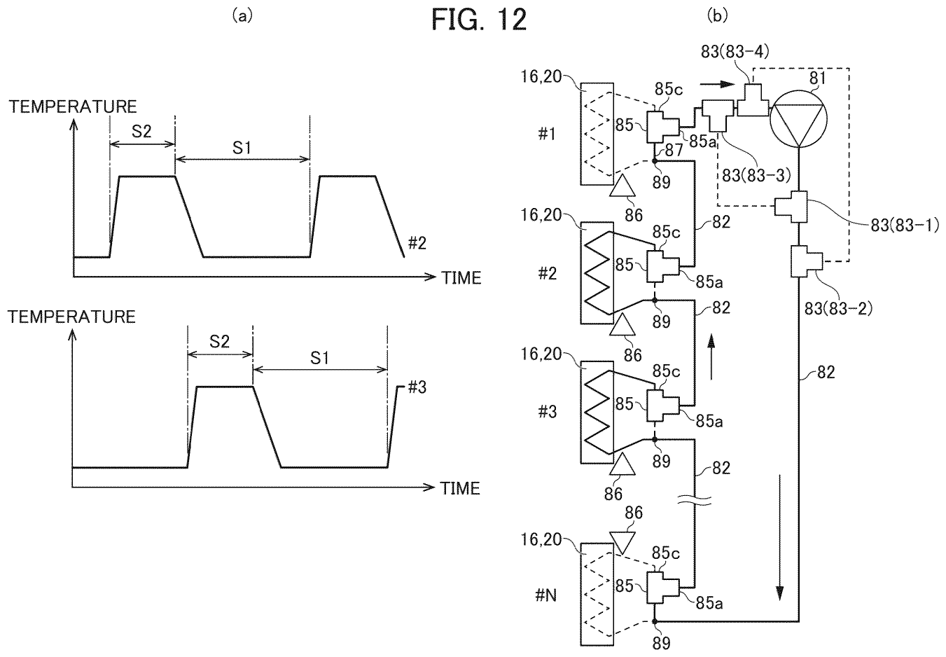

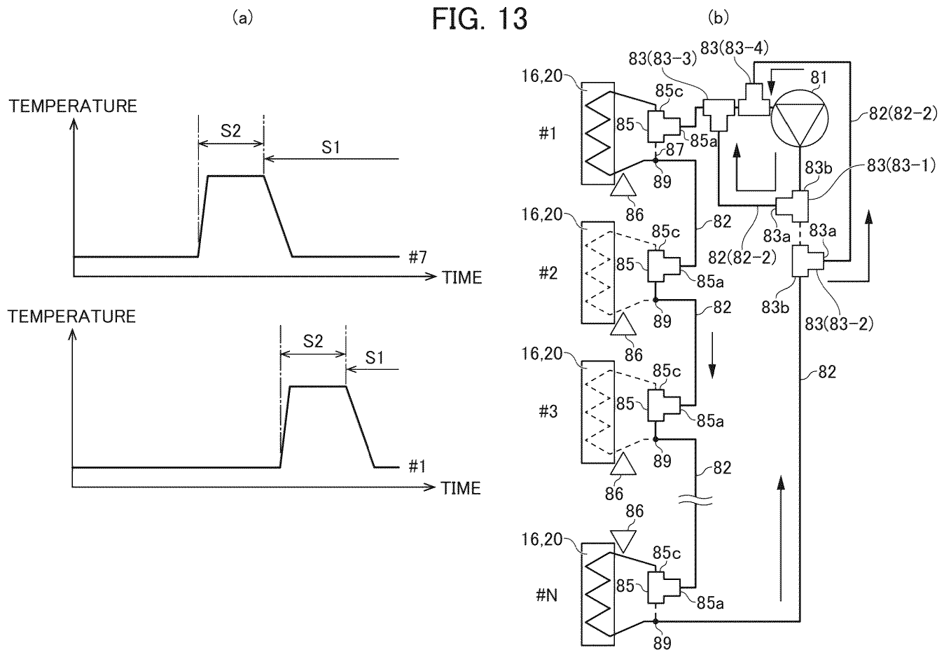

FIG. 12 is a view showing an example of the flow of heat transfer medium in the heat-transfer medium circuit of the heat pump 80. FIG. 12A is a graph showing the temperature of the adsorption material 20 of the No. 2 (#2) and No. 3 (#3) modules and time, with the vertical axis being temperature, and the horizontal axis being time. In FIG. 12A, the first half of the adsorption step of the adsorption material 20 of No. 2 (#2) and the first half of the desorption step of the adsorption material 20 of No. 3 (#3) are corresponding. FIG. 12B shows the flowpath and direction of heat transfer medium in corresponding time bands, and in order to facilitate understanding, the pipes in which the heat transfer medium flows are indicated by solid lines, and the pipes in which the heat transfer medium does not flow are indicated by broken lines. Modules other than No. 2 (#2) and No. 3 (#3) shall be performing the adsorption step. It should be noted that FIG. 12 and FIG. 13 described later are illustrated giving the example in which N number of modules are arranged in one module unit 10. N is a positive integer, and shall satisfy (Equation 2) described above (N=N2).

As shown in FIG. 12, in the first half of the adsorption step by the No. 2 (#2) module and the first half of the desorption step by the No. 3 (#3) module, the heat transfer medium compressed by the compressor 81 of the heat pump 80 and reaching a high temperature passes through the pipe 82 and the switching valve 83, and flows in the first flow direction, which is the direction of the arrows indicated in the drawings. The heat transfer medium first reaches the No. N (#N) module. The heat transfer medium is flowed from the branch 89 to the bypass 87, is flowed from the port 85b of the switching valve 85 to the port 85a and led to the pipe 82, and then led to the No. N−1 module (not shown). Therefore, without flowing in the heat exchanger 16 of No. N (#N), the adsorption material 20 of No. N (#N) will not be heated, and thus remains at room temperature.

The flowpaths of the heat transfer medium within the No. N−1 (not shown) to No. 4 modules are the same as the No. N (#N) module. The heat transfer medium having reached the No. 3 (#3) module is led from the branch 89 to the tube 88, and flows within the heat exchanger 16 to heat the adsorption material 20. Then, the heat transfer medium flows from the port 85c of the switching valve 85 to the port 85a, and passes through the pipe 82 and led to the No. 2 (#2) module. At this time, the temperature of the heat transfer medium drops compared to before arrival at the No. 3 (#3) module.

The heat transfer medium having reached the No. 2 (#2) module flows in the tube 88 within the heat exchanger 16 in a state in which the expansion valve 86 is open to expand, and the temperature drops. At this time, the adsorption material 20 of No. 2 (#2) reaches a high temperature due to the thermal energy supplied in the desorption step. The heat transfer medium flowing in the tube 88 of the heat exchanger 16 of No. 2 (#2) absorbs the heat of the surroundings, and the temperature of the adsorption material 20 drops. By the heat transfer medium continuously flowing within the heat exchanger 16 while absorbing heat, the adsorption material 20 drops to room temperature (25 °C), which is suited to the adsorption step. Then, the heat transfer medium having risen in temperature by heat absorption flows from the port 85c of the switching valve 85 to the port 85a, and passes through the pipe 82 and led to the No. 1 (#1) module.

In the No. 1 (#1) module, similarly to the No. N module, the heat transfer medium flows from the branch 89 through the bypass 87 to the switching valve 85, flows from the port 85b of the switching valve 85 to the port 85a and is led to the pipe 82. Then, the heat transfer medium passes through the pipe 82, switching valve 83, etc. and returns to the compressor 81. By the heat transfer medium flowing in the heat-transfer medium circuit as mentioned above, the adsorption material 20 of No. 2 (#2) is cooled to a temperature suited to the adsorption temperature, and the adsorption material 20 of No. 3 (#3) is heated to a temperature (90 °C) suited to the desorption step. In addition, in modules other than No. 2 and No. 3, the adsorption material 20 is not heated, and thus is maintained as is at room temperature. The transfer of such thermal energy is similar not only between the above-mentioned No. 2 (#2) and No. 3 (#3) modules, but also between other adjacent modules such as the No. 3 (#3) and No. 4 (#4) modules.

The recovery and supply of thermal energy between adjacent modules 11 is carried out as described above. Next, the recovery and supply of thermal energy between non-adjacent modules 11 is carried out in the following way.

FIG. 13 is a view showing an example of the flow of heat transfer medium in the heat-transfer medium circuit of the heat pump 80. FIG. 13A is a graph showing the temperature of the adsorption material 20 of the No. N (#N) and No. 1 (#1) modules and time, with the vertical axis being temperature, and the horizontal axis being time. In FIG. 13A, the first half of the adsorption step of the adsorption material 20 of No. N (#N) and the first half of the desorption step of the adsorption material 20 of No. 1 (#1) are corresponding. FIG. 13B shows the flowpath and direction of heat transfer medium in corresponding time bands, and in order to facilitate understanding, the pipes in which the heat transfer medium flows are indicated by solid lines, and the pipes in which the heat transfer medium does not flow are indicated by broken lines. It should be noted that modules other than No. N (#N) and No. 1 (#1) shall be carrying out the adsorption step.

At the point in time at which the No. N (#N) module starts the adsorption step, the controller 70 switches the communication state of the switching valves 83 (83-1 to 83-4) provided in the pipe 82 of the heat pump 80, and temporarily establishes the flowpath and flow direction of the heat transfer medium in the heat-transfer medium circuit to a second direction which is the opposite direction to the direction thus far. As shown in FIG. 13B, first, the heat transfer medium compressed by the compressor 81 and having reached high temperature flows from the pipe 82 and from the port 83b of the switching valve 83-1 to the port 83a, flows through the pipe 82-2 from the port 83a of the switching valve 83-3 to the port 83b, and is led through the pipe 82-2 to the No. 1 (#1) module. The heat transfer medium flows from the port 85a of the switching valve 85 to the port 85c of the No. 1 (#1) module, and flows inside the tube 88 within the heat exchanger 16. The adsorption material 20 is thereby heated to reach a temperature (90 °C) appropriate for the desorption step. At this time, the temperature of the heat transfer medium drops compared to before reaching the No. 1 (#1) module.

The heat transfer medium is led from the tube 88 through the branch 89 to the pipe 82, and leaves the No. 1 (#1) module. Then, the heat transfer medium reaches the No. 2 (#2) module through the pipe 82. The heat transfer medium flows from the port 85a to the port 85b of the switching valve 85 of the No. 2 (#2) module, passes through the bypass 87, flows to the pipe 82 via the branch 89, and is led to the No. 3 (#3) module. In other words, the heat transfer medium does not flow within the heat exchanger 16 of the No. 2 (#2) module, and the adsorption material 20 maintains room temperature. Also in the No. 3 (#3) to No. N−1 (not shown) modules, etc., the heat transfer medium does not flow within the heat exchanger 16, and passes through the switching valve 85 and the bypass 87 and is led to the next module. Therefore, in the No. 3 (#3) to No. N−1 modules, the adsorption material 20 maintains room temperature.

The heat transfer medium arriving at the No. N (#N) module is decompressed and expands by the expansion valve 86 provided in the tube 88 being opened, and the temperature drops. The heat transfer medium absorbs the heat of the surroundings by flowing in the tube 88 within the heat exchanger 16 of No. N (#N) in the low temperature state, and causes the temperature of the adsorption material 20 to drop. The heat transfer medium having the raised in temperature by heat absorption flows to the pipe 82 from the tube 88 via the branch 89 and is led to the compressor 81. Then, the heat transfer medium flows from the port 83b of the switching valve 83-2 to the port 83a, and passes through the pipe 82 and is led to the switching valve 83-4. Then, it flows from the port 83a of the switching valve 83-4 to the port 83b, and passes through the pipe 82 to enter the compressor 81.

In the aforementioned way, the controller 50 switches the communication, etc. of the switching valves 83 and 85 provided to the pipe 82 of the heat-transfer medium circuit of the heat pump 80. It is thereby possible to temporarily flow the heat transfer medium in the opposite direction in the heat-transfer medium circuit, and possible to efficiently carry out the recovery and supply of thermal energy between non-adjacent modules 11. It should be noted that, when the No. 1 (#1) module 11 finishes the desorption step, the communication, etc. of the switching valve 83 is switched, and the flow direction of the heat transfer medium within the heat-transfer medium circuit of the heat pump 80 returns to the first flow direction, which is the original direction, by way of the control of the controller 50. Then, the thermal energy of the No. 1 (#1) module is recovered by the heat transfer medium, and supplied to the thermal energy of No. 2.

In view of the above, by establishing the heat-transfer medium circuit of the present embodiment, and the waste heat recovery heat pump 80 including this, it is possible to efficiently transfer the unwanted thermal energy in a certain module 11 to a module 11 requiring thermal energy. In addition, according to the carbon dioxide recovery device 1 of the present embodiment, it is possible to recover unwanted heat by the waste heat recovery-type heat pump 80, and thus possible to reduce the electric power consumed in the supply of thermal energy upon each module 11 performing the desorption step. In addition, according to the present embodiment, it is possible to drive the heat pump with higher COP, and thus possible to reduce the electric power consumed in the supply of thermal energy.

### Modified Embodiments

Not limiting to the above described embodiments, various modifications and changes thereto are possible, and these are also within the scope of the present invention.

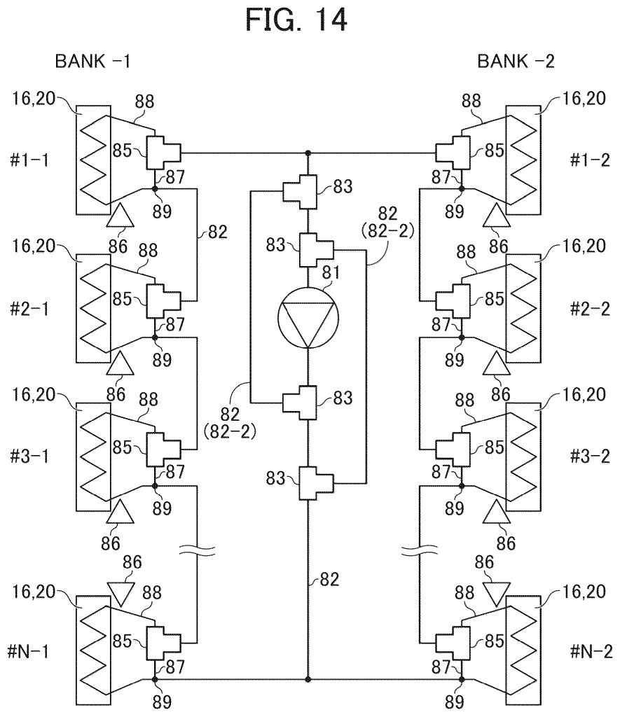

The heat-transfer medium circuit of the heat pump 80 may be established in the following such form. FIG. 14 is a view showing an example of a heat-transfer medium circuit of the heat pump 80 in the case of establishing the module number as N×2. In the case of establishing the module number as N×2, as shown in FIG. 14, the heat-transfer medium circuit of the heat pump 80 assumes a form including a bank 1 including N number of modules 11, and a bank 2 including N number of modules 11. Then, in the heat-transfer medium circuit of this heat pump 80, the No. n (#n−1) module 11 of bank 1 assumes a configuration operating in the same phase as the No. n (#n−2) module 11 of bank 2. This number N is an integer multiple of the number N0 obtained by the aforementioned (Equation 2). In addition, it is preferable to satisfy the aforementioned (Equation 1).

In addition, by a plurality of the switching valves 83 (83-1 to 83-4) and the pipe 82-2 being provided in the heat-transfer medium circuit, and controlling the switching of communication of these switching valves 83, it is possible to switch the flow direction, etc. of the heat transfer medium as shown in the aforementioned FIGS. 12 and 13. By establishing such a configuration, even in the case of the number of modules 11 increasing, it is possible to carry out the recovery and supply of thermal energy efficiently with one compressor 81, and thus possible to suppress power consumption required in the supply of thermal energy in the desorption step of the modules 11.

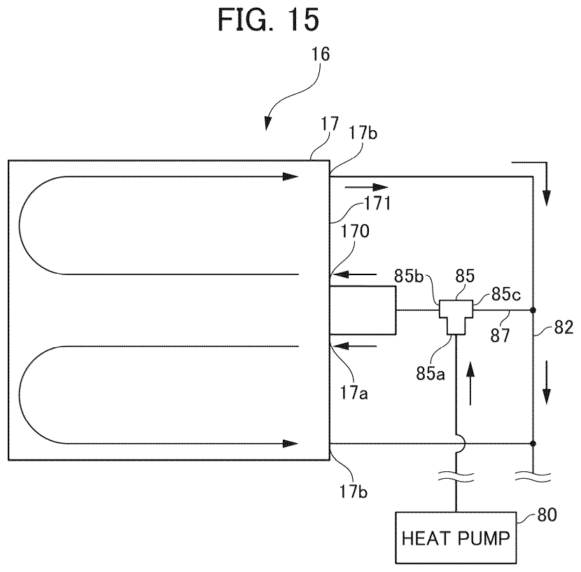

In addition, the flowpath (tube) of the heat transfer medium flowing within the heat exchanger 16 of the module 11 is preferably established in the following such form. FIG. 15 is a view showing an example of the flow of heat transfer medium in the heat exchanger 16. FIG. 15 shows, as an example, a case of high-temperature heat transfer medium flowing in from the compressor 81 of the heat pump 80. The high-temperature heat transfer medium flows from the port 85a of the switching valve 85 to the port 85b, and flows into a tube (not shown) in a layer 17 from an inflow portion 17a provided in a side 171 of the layer 17. Then, depicting a U shape as shown in FIG. 15, the heat transfer medium flows out from the outlet portion 17b provided on the same side 171, and passes through the pipe 82 and is led to the next module. By setting the outlet/inlet of heat transfer medium, and arranging tubes so that the heat transfer medium flows in the layer 17 in a U shape in this way, it is possible to minimize the length of the bypass 87 connected from the port 85b of the switching valve 85 to the pipe 82. It is thereby possible to simplify the structure of the heat-transfer medium circuit, and thus possible to curb the loss of thermal energy of the heat transfer medium by flowing in a long flowpath.

It should be noted that, although the present embodiment and modified examples can be used in combination as appropriate, detailed explanations thereof will be omitted. In addition, the present invention is not to be limited by the embodiments, etc. described above.

### EXPLANATION OF REFERENCE NUMERALS

1 carbon dioxide recovery circuit
10 module unit
11 module
12 valve
13 valve
14 valve
16 heat exchanger
20 adsorption material
50 controller
61 fan
62 vacuum pump
63 compressor
64 tank
80 heat pump
81 compressor
82 pipe
83 switching valve

1. A carbon dioxide recovery device comprising:
a plurality of carbon dioxide recovery modules, each including an adsorption material that adsorbs and desorbs carbon dioxide, and performing an adsorption step of adsorbing carbon dioxide to the adsorption material, and a desorption step of desorbing the carbon dioxide adsorbed to the adsorption material;
a heat pump that transfers thermal energy between a plurality of the carbon dioxide recovery modules; and
a controller that controls operation of the carbon dioxide recovery modules and the heat pump,
wherein the controller
drives each of the carbon dioxide recovery modules in an operation cycle of alternately performing the adsorption step and the desorption step, and
drives the plurality of the carbon dioxide recovery modules to evenly shift a phase of the operation cycle of each,
wherein the heat pump causes thermal energy to transfer from the carbon dioxide recovery module which is in a latter half of the desorption step or a first half of the adsorption step to the carbon dioxide recovery module which is immediately before start of the desorption step or in a first half of the desorption step, and
wherein a number of the carbon dioxide recovery modules is an integer multiple of a number N0 satisfying an Equation 2 below, when setting a time required for the adsorption step as x seconds, setting a time required for the desorption step as y seconds, and setting a time difference allowed between a point in time when starting the adsorption step of the carbon dioxide recovery module having started the adsorption step, and a point in time when starting the desorption step of the carbon dioxide recovery module having started the desorption step as z seconds.
$$\begin{matrix}[ Expression 1 ] & \\ \vert \frac{x + y}{N 0} - y \vert ≦ z & ( Formula 2 )\end{matrix}$$

2. The carbon dioxide recovery device according to claim 1, wherein the heat pump supplies thermal energy recovered from the carbon dioxide recovery module which is in the latter half of the desorption step or the first half of the adsorption step to the carbon dioxide recovery module which is immediately before start of the desorption step or in the first half of the desorption step.
